(19) United States
(12) Patent Application Publication
(10) Pub. No.: US 2025/0076073 A1
(43) Pub. Date: Mar. 6, 2025

(54) LOCATION-BASED AND FUNCTION-BASED LOCATION FILTERING

(71) Applicant: Capital One Services, LLC, McLean, VA (US)

(72) Inventors: Trevor CONNOLLY, Brooklyn, NY (US); Louise LOPEZ, Wilmington, DE (US); Valerie CHOU, Silver Spring, MD (US); Euihyun HWANG, Arlington, VA (US); John STORM, Wilmington, DE (US)

(21) Appl. No.: 18/456,785

(22) Filed: Aug. 28, 2023

(51) Int. Cl. G01C 21/36; G06F 16/9537

(52) U.S. Cl. CPC G01C 21/3682; G01C 21/3664; G06F 16/9537

(57) ABSTRACT

In some implementations, a device may obtain, via a visual element of a user interface, a request to filter a location element of the user interface by a function, wherein the visual element indicates the function, and wherein the device is associated with a device location. The device may search, based on obtaining the request, first information associated with a set of locations to identify one or more locations that are: one or more physical locations at which the function is performable and that are within a threshold distance from the device location, or one or more digital locations at which the function is performable. The device may provide, for display, the user interface including the location element depicting second information associated with the one or more locations.

### BACKGROUND

A graphical user interface is a form of user interface that allows users to interact with electronic devices. An application or a web browser may provide a graphical user interface that presents pages. A user may navigate to a page by entering an address into an address bar of the web browser and/or by clicking a link displayed via the graphical user interface. Navigation to a page may consume resources of a device on which the web browser is installed and/or on which the application is executing, may consume resources of a server that serves the page to the device, and/or may consume network resources used for communications between the device and the server.

### SUMMARY

Some implementations described herein relate to a system for location-based and function-based location filtering. The system may include one or more memories and one or more processors communicatively coupled to the one or more memories. The one or more processors may be configured to provide, for display, a user interface that includes a location element that indicates physical locations. The one or more processors may be configured to obtain, via a filter chip of the user interface, a request to filter the location element by a function, wherein the filter chip indicates the function. The one or more processors may be configured to filter, using a device location associated with the system and the function, one or more locations from a set of locations, wherein filtering using the function includes identifying that the function is performable at the one or more locations. The one or more processors may be configured to provide, for display and based on obtaining the request to filter the location element by the function, the location element indicating the one or more locations.

Some implementations described herein relate to a method of location-based and function-based location searching. The method may include obtaining, by a device and via a visual element of a user interface, a request to filter a location element of the user interface by a function, wherein the visual element indicates the function, and wherein the device is associated with a device location. The method may include searching, by the device and based on obtaining the request, first information associated with a set of locations to identify one or more locations that are, one or more physical locations at which the function is performable and that are within a threshold distance from the device location, or one or more digital locations at which the function is performable. The method may include providing, by the device and for display, the user interface including the location element depicting second information associated with the one or more locations.

Some implementations described herein relate to a non-transitory computer-readable medium that stores a set of instructions. The set of instructions, when executed by one or more processors of a device, may cause the device to provide, for display, a user interface that includes a location element that depicts location indicators. The set of instructions, when executed by one or more processors of the device, may cause the device to obtain, via a filter chip of the user interface, a request to filter the location element by a function. The set of instructions, when executed by one or more processors of the device, may cause the device to filter, using a device location associated with the device and the function, one or more locations from a set of locations, wherein the function is performable at the one or more locations. The set of instructions, when executed by one or more processors of the device, may cause the device to provide, for display and based on obtaining the request to filter the location element by the function, the location element indicating the one or more locations.

### BRIEF DESCRIPTION OF THE DRAWINGS

FIGS. 1A-1D are diagrams of an example associated with location-based and function-based location filtering, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with location-based and function-based location filtering, in accordance with some embodiments of the present disclosure.

FIG. 4 is a flowchart of an example process associated with location-based and function-based location filtering, in accordance with some embodiments of the present disclosure.

### DETAILED DESCRIPTION

The following detailed description of example implementations refers to the accompanying drawings. The same reference numbers in different drawings may identify the same or similar elements.

Graphical user interfaces (GUIs) provide users with an intuitive and interactive way to interact with digital systems. A GUI may be a visual representation of a software application and/or operating system that allows users to control and manipulate objects using graphical elements, such as windows, icons, menus, buttons, links, pages, chips, and/or other graphical controls, among other examples. In some examples, a graphical element of a GUI may include a filter chip. A filter chip may be a graphical element or control that allows users to apply filters or refine search criteria within a given context. A filter chip may display a selected filter option or criterion, indicating a user's current filtering selection. Multiple filter chips can be displayed simultaneously to represent multiple applied filters.

When a user interacts with a filter chip, the interaction triggers an action to either activate or deactivate the filter associated with the filter chip. Activating a filter narrows down the displayed content, showing only the items that meet the selected criteria. Deactivating or removing a filter expands the displayed content to include all items again. By using filter chips, users can easily refine a search or narrow down displayed information, allowing for more efficient data exploration and content discovery. Filter chips enhance the user experience by providing a visual and interactive way to manage and modify filtering options, helping users find desired information quickly and easily.

In some examples, a GUI may include a location element that is associated with displaying location information for one or more physical locations. For example, the location element may include a map display that depicts indications of geographic locations of one or more physical locations (e.g., one or more physical locations of an entity, such as stores, branches, or other physical locations). For example, the GUI and/or location element may be associated with a location filter chip. The location filter chip may be type of filter chip used in GUIs to apply filters or refine search results based on geographical or location-related criteria. In some examples, a user may search (e.g., using the location element and/or one or more location filter chips) for a physical location to visit. Often, the user may be searching for a physical location for the purposes of performing a function or receiving a service at the physical location. Typically, the location element may enable the user to search by geographical or location-related criteria (e.g., to identify physical locations near a user device on which the GUI is displayed). Additionally, the location element may enable the user to search by location type (e.g., to refine the search results to one or more location types that may be associated with the function or the service).

However, not all physical locations of a given location type offer the same services and/or functions. For example, the location type may be branches of a financial institution. A first branch may offer a first service or a first function may be performable at the first branch. However, a second branch may not offer the first service and/or the first function may not be performable at the first branch. As a result, searching by location and/or location type may result in search results that are not useful and/or misleading for the user (e.g., resulting in a poor user experience). For example, searching by location and/or location type may result in one or more “false positive” search results that identify a physical location that meets the location and/or location type search criteria, but that do not actually offer and/or support a given function and/or service. This may consume computing resources, processing resources, memory resources, and/or power resources, among other examples, associated with the user device filtering and/or identifying the search results that are not useful and/or misleading for the user. Additionally, this may result in computing resources, processing resources, memory resources, and/or power resources, among other examples, being consumed by the user navigating to other pages and/or other applications to confirm that a physical location identified in the search results actually offers and/or supports a given function and/or service.

Additionally, in some cases, the user may be unaware that a given location type offers and/or supports a given function and/or service. Therefore, the user may filter search results by other location types, resulting in overly narrow search results. However, it may be difficult to identify which services and/or functions are offered or supported by a given physical location. For example, an entity may be associated with a distributed infrastructure with multiple physical locations and interconnected systems where each physical location may offer a subset of services based on one or more factors, such as customer demand, regional requirements, and/or local regulations, among other examples. Identifying the specific services offered by a particular physical location may require gathering information from various decentralized sources, such as branch-specific databases, legacy systems, and/or service documentation, among other examples (e.g., which may be difficult to access and/or coordinate). Further, physical locations may introduce new services and/or update existing services to meet evolving customer needs and industry trends. Tracking such changes and maintaining an up-to-date understanding of the services offered by each physical location is a significant challenge. Additionally, relevant information about a functions and/or services offered or supported by different physical locations may be scattered across multiple sources, such as internal documentation, website content, customer service records, and/or regulatory disclosures, among other examples. Aggregating and consolidating this information can be a complex task, such as when the data is fragmented, inconsistent, and/or stored in different formats.

Some implementations described herein enable location-based and function-based location filtering. In some implementations, a user device may display a user interface that includes a filter chip (or other graphical element) associated with filtering location-based search results of physical locations (and/or digital locations) by a function and/or service. For example, the user device may provide a user interface for display that includes a location element that indicates physical locations (e.g., via a map display and/or a list of location information for respective physical locations). The user device may obtain, via a filter chip (or another graphical element) of the user interface, a request to filter results indicated by the location element by a function. The user device may filter, using a device location associated with the user device and the function, one or more locations from a set of locations (e.g., where the set of locations satisfy or meet geographical and/or location-based criteria). For example, filtering using the function may include identifying that the function is performable at the one or more locations. The user device may provide, based on obtaining the request to filter the location element by the function, the location element for display (e.g., via the user interface) indicating the one or more locations (e.g., where the one or more locations are associated with different location types at which the function is performable).

In some implementations, the user device may identify whether the function is performable at the one or more locations via a multi-stage searching process. For example, the user device may filter, to obtain a subset of locations, a set of locations (e.g., that locations satisfy or meet geographical and/or location-based criteria) by one or more location types that are associated with supporting the function. The user device may determine whether the function is currently performable at each location included in the subset of locations (e.g., where the one or more locations include locations, from the subset of locations, at which the function is currently performable). For example, the user device may obtain information from a database that indicates functionality information for respective locations. The user device may search the database for functionality information for a given location (e.g., using an identifier of the location which may be obtained from filtering the set of locations). Filtering the set of locations by the one or more location types may reduce a complexity and/or reduce processing resources and/or computing resources that would have otherwise been associated with searching for and/or analyzing functionality information for all locations included in the set of locations.

As a result, by enabling both location-based filtering and function-based filtering of locations, search results for locations may be associated with improved utility and/or accuracy for a user. For example, the search results may include all locations (e.g., nearby a user device) at which a given function may be performed (e.g., including multiple location types). As a result, the search results may provide more insightful information for the user because the search results may depict and/or indicate physical locations that are located near the user device and at which the desired function can actually be performed. This conserves computing resources, processing resources, memory resources, and/or power resources, among other examples, associated with the user device filtering and/or identifying the search results that are not useful and/or misleading for the user (e.g., search results that include one or more false positive results). Further, this conserves computing resources, processing resources, memory resources, and/or power resources, among other examples, that would have otherwise been used by the user navigating to other pages and/or other applications to confirm that a physical location identified in the search results actually offers and/or supports a given function and/or service.

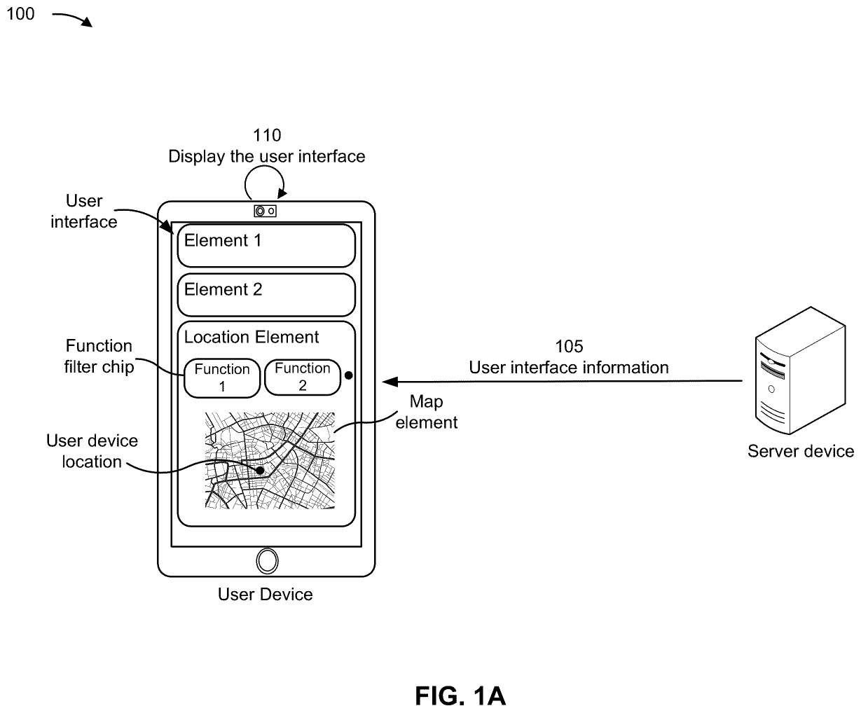

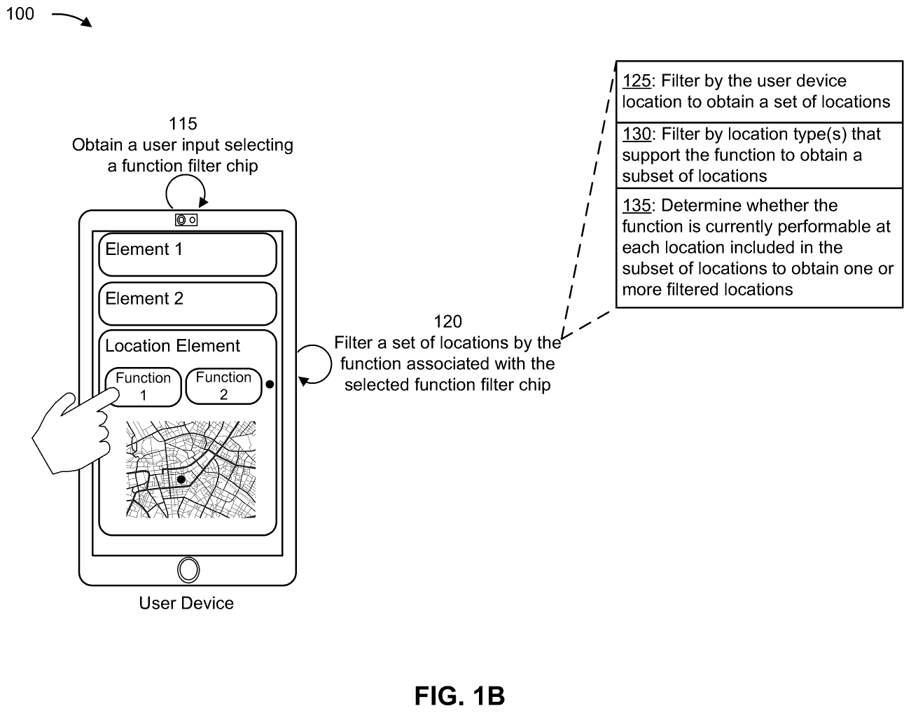

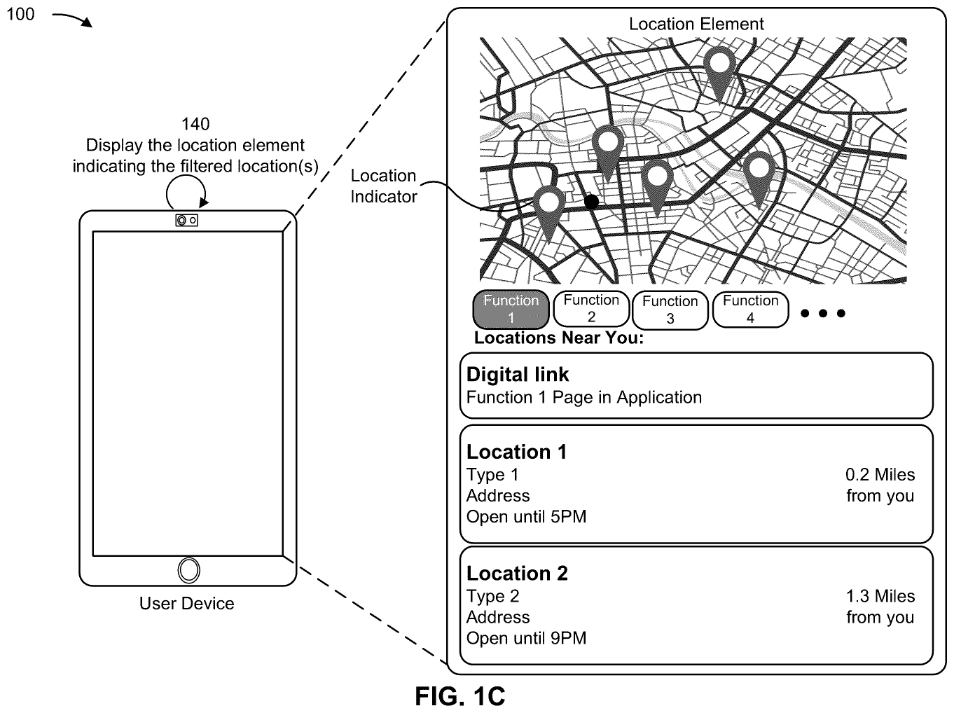

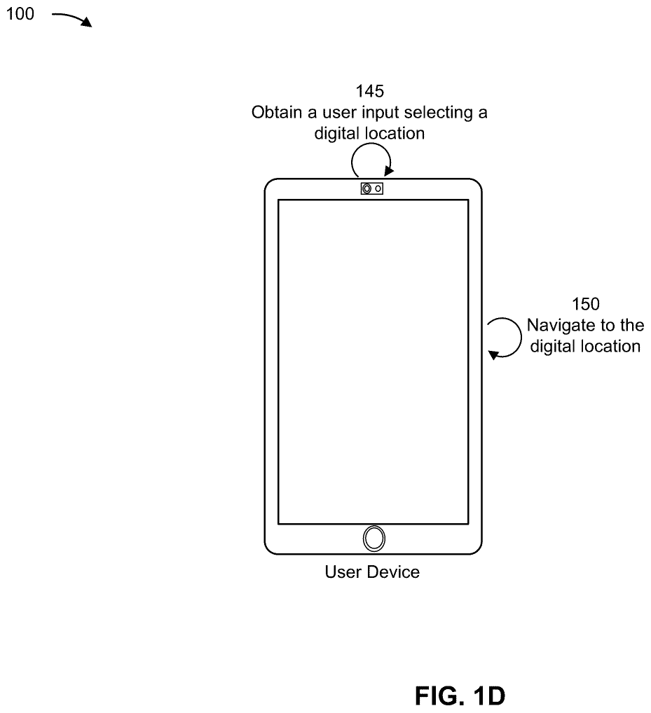

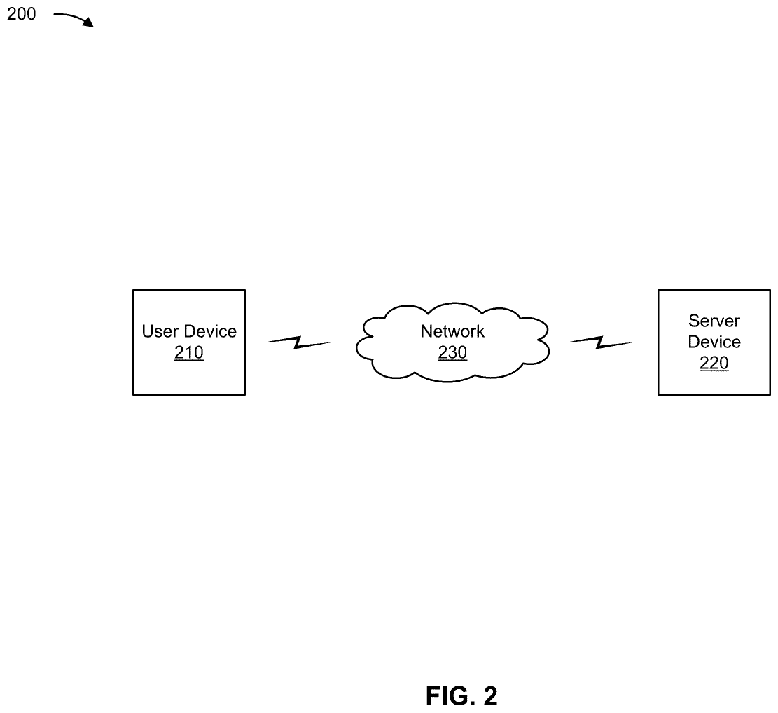

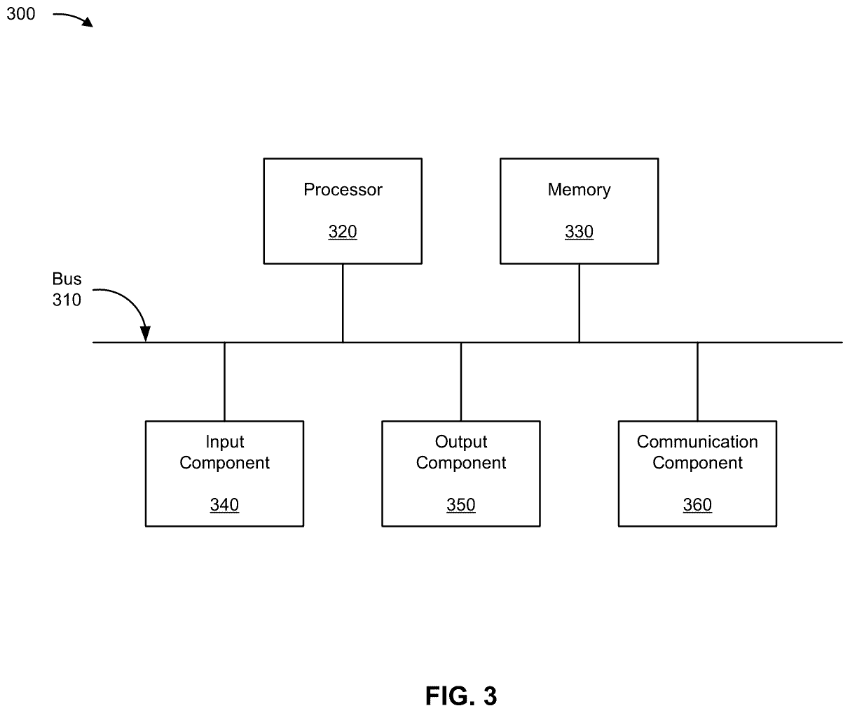

FIGS. 1A-1D are diagrams of an example 100 associated with location-based and function-based location filtering. As shown in FIGS. 1A-1D, example 100 includes a user device and a server device. These devices are described in more detail in connection with FIGS. 2 and 3.

As shown in FIG. 1A, and by reference number 105, the server device may transmit, and the user device may receive, user interface information. The user interface information may enable the user device to display a user interface, as described herein. For example, the user interface information may include display information that enables the user device to display the user interface.

In some implementations, the user interface information may include location information associated with a set of locations (e.g., physical locations and/or digital locations). As used herein, a “physical location” may refer to a location that is associated with a geographic location (e.g., a physical structure, a physical building, and/or a “brick-and-mortar” location). For example, a physical location may include a building, a branch, a store, a café, a cash machine (e.g., an automated teller machine (ATM)), and/or other types of physical locations. A digital location may refer to a location in a digital domain. For example, a digital location may include a page of an application, an application, a website, a web page, and/or other types of digital locations.

For example, the user interface information may include one or more databases associated with identifying information for respective locations. As an example, the one or more databases may indicate location types of respective locations. Additionally, the one or more databases may indicate one or more functions or services supported by respective locations. In some implementations, the user device may directly access and/or search the one or more databases. In other implementations, the user device may communicate with the server device (or another server device), and the server device may access and/or search the one or more databases (e.g., in response to a request from the user device).

As shown by reference number 110, the user device may provide, for display, the user interface (e.g., the user device may display the user interface, such as via a display screen). The user interface may be a GUI. For example, the user interface may include one or more graphical elements (e.g., shown as “Element 1,” “Element 2,” and “Location Element”). The location element may be associated with indicating and/or depicting location information for one or more locations (e.g., with respective to a location of the user device). The location of the user device (e.g., a geographic location of the user device) may be referred to as a “user device location” and/or a “device location” herein.

For example, the location element may include a map element. The map element may be an interactive graphical element that depicts a map with an indication of the user device location. For example, a user may interact with the map element using gestural interactions (e.g., a swipe, a pinch, a touch and drag, and/or another type of gestural interaction) to move the area displayed by the map element, such as by moving in a cardinal direction, by zooming in, and/or by zooming out, among other examples. Additionally, the map element may depict indications of one or more physical locations (e.g., to provide an indication of the physical locations relative to the user device location). For example, the map element may depict physical locations that are near the user device location.

The location element may enable a user to search for one or more locations (e.g., one or more physical locations and/or one or more digital locations). For example, the location element may include indications of one or more locations that are near the user device location (e.g., where a distance between the user device location and a physical location satisfies a distance threshold). As an example, the distance threshold may be a parameter that is set by the user (e.g., the user may input the distance threshold to the user device via the user interface). As an example, the distance threshold may be 10 miles and the user device may cause the location element to include indications of one or more physical locations that are within 10 miles of the user device location. Searching for physical locations that are near the user device location, as described above, may be referred to herein as “location-based searching” or “location-based filtering.”

The user interface may include one or more elements associated with filtering location-based search results by a function. For example, as shown in FIG. 1A, the location element may include one or more filter chips associated with filtering location-based search results by a function (e.g., referred to herein as “function filter chips”). Although some examples are described herein using the function filter chip as an example element used to indicate different function-based filtering that can be applied, examples described herein may be implemented using any visual element or graphical element of a user interface (e.g., the examples described herein are not limited to filter chips). As used herein, a “function” may refer to an act, a capability, a service, an operation, an interaction, a transaction, an exchange, and/or another function that associated with a location (e.g., that is performable by a user at a physical location or via a digital location). As an example, the function may be associated with an entity that is associated with the user interface. For example, the user interface may be part of an application that is associated with an entity. The function may be a function that is performable by the user with the entity.

As an example, the entity may be a financial institution. In such examples, the function may include withdrawing cash, depositing cash, obtaining a certified check (e.g., a cashier's check), meeting with a financial advisor, making a credit card payment, opening a new account, closing an existing account, and/or another function offered or supported by the financial institution. As another example, the entity may be a retail store. In such examples, the function may include purchasing an item (e.g., a specific item, a category of items, and/or any item), returning an item, obtaining servicing for an item (e.g., a repair or maintenance for an item), obtaining operational help for an item (e.g., guidance or training on how to use or operate an item), and/or another function offered or supported by the retail entity. In other words, the function may be any function that is offered and/or supported by a given entity.

As shown in FIG. 1A, the user interface may include multiple function filter chips associated with respective functions (e.g., multiple visual elements associated with filtering locations by a given function). A user may select one or more function filter chips to filter location-based search results by locations that offer and/or support the function(s) corresponding to the selected function filter chip(s), as described in more detail elsewhere herein. In some implementations, the multiple function filter chips may be presented in an order. The order may be based on historical user interactions with the user interface, with the application or webpage associated with the user interface, and/or with the location element. For example, the order may be based on previous filtering selections by the user. For example, the order may present a function filter chip (e.g., associated with a function) first that the user has previously selected and/or interacted with. In other words, the order may present function filter chips that the user is more likely to select (e.g., based on historical or previous interactions) before function filter chips that the user is less likely to select. This reduces the amount of navigation needed to be performed by the user to identify and/or select a given function filter chip, thereby conserving computing resources and/or processing resources and improving the user experience.

In some implementations, the location element may include a search field to search for a function to be used as a filter, as described herein. For example, the user interface may include a set of function filter chips associated with respective functions. However, in some cases, a function that a user wishes to search for and/or filter by may not be include in the respective functions. The search field may enable the user to search for other functions that are available to be used as a filter and/or search criteria. In some implementations, the search results may include a function that is selectable by the user. A selection of the function may cause the user device to generate a service filter chip associated with the function to be displayed via the user interface. The user may select the generated service filter chip to filter the location-based search results by the function. In some implementations, the search results may indicate that the function is not associated with any filter chips. In such examples, the user device may transmit, and the server device may receive, an indication of the function (e.g., for which the user searched for but had no results). This may enable the entity associated with the user interface to identify functions that are being searched for by users, but that are currently not associated with function filter chips. As a result, the entity may be enabled to modify one or more databases or search criteria to enable the function to be associated with a service filter chip, as described in more detail herein (e.g., the entity may be enabled to perform one or more actions to enable a service filter chip associated with the function to be associated with the user interface).

As shown in FIG. 1B, and by reference number 115, the user device may obtain a user input selecting a function filter chip. For example, the user may provide a gestural interaction (e.g., a tap, a swipe, a pinch, or another gestural interaction) to select the function filter chip. The user device may detect the gestural interaction and determine that the function filter chip has been selected by the user. The function filter chip may be associated with a function (e.g., “Function 1” as shown in FIG. 1B). For example, the user device may obtain, via the selection of the function filter chip of the user interface, a request to filter the location element by the function (e.g., the function filter chip may indicate the function). Obtaining the user input selecting the function filter chip may cause the user device to filter location-based search results by the function associated with the function filter chip, as described in more detail elsewhere herein.

For example, as shown by reference number 120, the user device may filter a set of locations by the function associated with the selected function filter chip. For example, the user device may filter, using the user device location and the function, one or more locations from the set of locations. Filtering using the function may include identifying that the function is performable at the one or more locations. In some implementations, the user device may search, based on obtaining the request, first information associated with the set of locations to identify one or more locations at which the function is currently performable.

The set of locations may include one or more physical locations that satisfy or meet a location-based search criteria. For example, the location-based search criteria may include the distance threshold described above. In other words, the set of locations may include one or more physical locations that are near the user device location. For example, as shown by reference number 125, the user device may filter (or search) by the user device location to obtain the set of locations. In other words, the user device may identify one or more physical locations for which a distance between a location and the user device location satisfies the distance threshold. Additionally, the set of location may include one or more digital locations. The one or more digital locations may be digital locations associated with the entity that is associated with the user interface.

For example, the user device may filter the set of locations to obtain the one or more locations at which the function is currently performable. “Currently performable” may refer to the location offering or supporting the function and/or the function being currently available or operational at the location. For example, if a physical location is closed at a current time (e.g., if it is currently outside the operating hours of the physical location), then the function may not be currently performable at the location. As another example, if a machine, system, or component associated with performing the function at the location is currently out of service (e.g., is broken and/or is not operational), then the function may not be currently performable at the location (e.g., even though the function may otherwise be performable at the location).

As shown by reference number 130, the user device may filter the set of locations by one or more location types that support the function to obtain a subset of locations. For example, the user device may filter, to obtain the subset of locations, the set of locations by one or more location types that are associated with supporting the function. For example, as described elsewhere herein, a database (e.g., a location database) may include indications of location types associated with respective locations. Additionally, the user device may store, or access, an indication of one or more functions associated with respective location types.

As an example, a cash machine location type may support withdrawing cash and depositing cash, but may not support meeting with a financial advisor. As another example, a branch location type may support withdrawing cash, depositing cash, and meeting with a financial advisor. As another example, a third-party location may only support depositing cash. The user device may store a mapping between location types and supported functions. The user device may search the mapping (or database) by the function to identify one or more location types that support the function. The user device may identify one or more locations (e.g., the subset of locations) from the set of locations that are associated with the one or more location types that support the function.

As shown by reference number 135, the user device may determine whether the function is currently performable at each location included in the subset of locations to obtain one or more filtered locations. For example, the user device may determine whether the function is currently performable at each location included in the subset of locations. For example, the user device may analyze information associated with each location included in the subset locations to determine whether each location currently supports or offers the function. By filtering the set of locations by the location type(s) that support the function, the user device may conserve processing resources, computing resources, memory resources, and/or power resources, among other examples, that would have otherwise been used to analyze information associated with each location included in the set of locations.

For example, the user device may receive the information associated with the subset of locations from the server device. For example, the server device may transmit, and the user device may receive, a database including functionality information associated with multiple locations. The functionality information may indicate specific functions and include an indication of whether each function is currently performable at the given location. Additionally, the functionality information may include time windows during which the location is accessible (e.g., may include an indication of operating hours associated with the location).

Additionally, the functionality information may indicate dependencies between two or more locations. For example, a first location (e.g., a cash machine) may be included inside of a second location (e.g., a branch of the entity or a physical location associated with a third party entity). A dependency may indicate that in order for the first location to be accessible by a user, the second location must also be accessible by the user. As another example, a dependency may indicate that although the second location may be inaccessible (e.g., may be closed), the first location may be accessible by certain users (e.g., users that have an account or card associated with the entity).

The user device may determine whether a given location is accessible based on one or more dependencies associated with the given location. For example, the user device may identify that a first location, from the set of locations, is located in a second location and that the function is performable at the first location. The user device may include the first location in the one or more locations (e.g., the filtered location(s)) based on an availability or accessibility of the second location. If the user device determines that the given location is not currently accessible, then the user device may determine that the function is not currently performable at the given location (e.g., even if the given location otherwise supports or offers the function).

In some implementations, some locations may be associated with a location type that typically supports or offer the function, but a specific location associated with the location type may not currently offer or support the function. For example, most branches of the entity (e.g., that is associated with the user interface) may offer meetings with a financial advisor (e.g., where meeting with a financial advisor is the function). However, a given branch may not have a financial advisor that is available for meetings (e.g., the branch may not employee a financial advisor or the financial advisor may be otherwise unavailable). In such examples, although the location type of a branch may be associated with supporting the function, the function may not be currently performable at the specific branch location.

In some implementations, the user device may identify that a location, from the set of locations, is associated with a location type that supports the function and that the function is performable at the location. The user device may obtain information indicating that the function is currently unavailable at the location. For example, the user device may obtain (e.g., from the server device or another device) functionality information associated with the location that indicates real-time operational status information for the location. For example, the operational status information may indicate whether a system, machine, or component associated with performing the function is currently operational. As an example, a cash machine (e.g., an ATM) may support multiple functions corresponding to respective functions. In some examples, a system, machine, or component associated with the cash machine (e.g., that is associated with performing a given function) may break or otherwise become non-operational. The cash machine may provide (e.g., to the server device or another device) an indication that the given function is currently unavailable. The server device (or other device) may include an indication in operational status information associated with the cash machine that the given function is currently unavailable.

The user device may analyze operational status information and/or functionality information associated with each location included in the subset of locations (e.g., or for locations for which such information is available or accessible) to determine whether the function is currently performable at each location. In some implementations, the user device may determine whether to include a given location in the one or more locations (e.g., the filtered location(s)) based on the operational status information and/or functionality information associated with the given location. In some implementations, the operational status information and/or functionality information associated with a given location may include information associated with a device located at the given location. For example, the device may be an ATM device, a cash machine, a terminal (e.g., a transaction terminal), and/or another device associated with performing the function. For example, the operational status information and/or functionality information associated with a given location may include an indication of whether the device is currently operational and/or capable of performing the function. If the device is currently operational and/or capable of performing the function, then the operational status information and/or functionality information may indicate that the function is currently performable at the given location. If the device is not currently operational and/or is not capable of performing the function, then the operational status information and/or functionality information may indicate that the function is not currently performable at the given location.

For example, if operational status information associated with a location, included in the subset of locations, indicates that the function is currently offline or otherwise non-operational at the location, then the user device may determine that the function is not currently performable at the location. The user device may refrain, based on the function being currently unavailable at a given location, from including the given location in the one or more locations (e.g., the filtered location(s)). As another example, if operational status information associated with a location, included in the subset of locations, indicates that the function is currently online or otherwise available at the location, then the user device may determine that the function is currently performable at the location. The user device may include, based on the function being currently available at a given location, the given location in the one or more locations (e.g., the filtered location(s)).

In some implementations, the user device may determine whether the function is currently performable at a given location based on accessibility information associated with the given location. The accessibility information may indicate times during which the given location is accessible by users. For example, the accessibility information may indicate operating hours associated with the given location. The user device may determine, based on a current time and/or day and based on the accessibility information, whether the given location is currently accessible by the user. If the user device determines that the given location is not currently accessible by the user, then the user device may determine that the function is not currently performable at the given location.

The user device may include the one or more locations, from the subset of locations, at which the function is currently performable in the one or more filtered locations (e.g., in results of a filtering operation performed in response to the user input selecting the function filter chips). The user device may refrain from including any location, from the subset of locations, in the one or more filtered locations at which the function is not currently performable, as described elsewhere herein. In some implementations, the one or more locations (e.g., the one or more filtered locations) may include multiple locations associated with different location types. For example, the different location types may include a first one or more location types associated with a first entity (e.g., an entity associated with the user interface), a cash machine associated with the first entity, and/or second one or more location types associated with a second entity (e.g., where the second one or more location types provide services for the first entity), among other examples.

In some implementations, the one or more locations (e.g., the one or more filtered locations) may include one or more physical locations and/or one or more digital locations. For example, the user device may identify one or more digital locations that offer or support functionality to enable the user to perform the function.

In some implementations, the request to filter the location-based search results may include multiple functions to filter by. For example, the user input may indicate a selection of multiple function filter chips. In such examples, the one or more locations (e.g., the one or more filtered locations) may include locations at which all indicated functions are performable. For example, the user device may filter and/or determine the set of locations by each function included in the multiple functions in a similar manner as described above. For example, if the user device determines that at least one function (from the multiple functions) is not currently performable at a given location, then the user device may refrain from including the given location in the one or more locations (e.g., the one or more filtered locations).

As shown in FIG. 1C, and by reference number 140, the user device may display the location element (e.g., of the user interface) indicating the one or more filtered locations. For example, the user device may provide, for display and based on obtaining the request to filter the location element by the function, the location element indicating the one or more filtered locations. For example, the user device may cause the location element to depict information associated with the one or more filtered locations.

For example, as shown in FIG. 1C, the location element may include the map element that depicts indications of one or more physical locations included in the one or more filtered locations. As an example, the user device may cause the map element to depict location indicators for respective physical locations included in the one or more filtered locations. The location indicator may indicate a geographic location of the physical location in a map displayed via the map element. This enables the user to view the geographic locations of respective physical locations relative to the user device location quickly and easily.

Additionally, the location element may include information associated with respective locations included in the one or more filtered locations. For example, the location element may include a digital link associated with a digital location. The digital link may be a link to cause the user device to navigate to the digital location. As described elsewhere herein, the digital location may be a page in an application (e.g., the application associated with the user interface or another application), a website, a webpage, an application (e.g., that is installed on the user device), a page at which the application can be downloaded or installed, and/or another type of digital location.

The information associated with the one or more filtered locations may include information associated with respective physical locations (e.g., shown in FIG. 1C and “Location 1” and “Location 2”). For example, the information may include a location type, an address, accessibility information (e.g., operating hours or a time at which the physical location closes), and/or an indication of a distance between the physical location and the user device location, among other examples.

In some implementations, the one or more filtered locations may include a first location associated with a physical location and a second location associated with the physical location. The first location may be associated with a first location type and the second location may be associated with a second location type (e.g., the first location may be an ATM and the second location may be a branch of an entity, where the ATM is included in the branch). The map element of the user interface may include single location indicator associated with the physical location. The single location indicator may be associated with the first location based on the first location type having a higher priority level than a priority level of the second location type for the function.

In other words, when multiple locations are located at the same physical location (e.g., such as an ATM included inside a branch of a bank, where the ATM and the branch are considered separate locations at the same physical location), the user device may provide indicator(s) for one location based on priority levels of the location types. For example, the priority level may be based on the function (e.g., some location types may be preferred for performing a given function than other location types even if the function is performable at each of the location types). This may enable the user device to determine which location to provide a location indicator for where two or more locations are co-located. Additionally, this enables the user device to provide more relevant information to the user by providing the location indicator for the preferred location type (e.g., preferred by the user and/or the entity for performing the function).

As shown in FIG. 1D, and by reference number 145, the user device may obtain a user input selecting a digital location from the one or more filtered locations indicated by the user interface. For example, the user may provide a gestural interaction indicating a selection of the digital location. As shown by reference number 150, the user device may navigate to the digital location (e.g., based on, or in response to, the user selection of the digital location). For example, the user device may navigate, based on obtaining the indication of the user input selecting the digital location, to the digital location. This may reduce the amount of navigation that would otherwise be performed by the user to search for and/or navigate to the digital location, thereby conserving computing resources, processing resources, and/or memory resources, among other examples. For example, the user may not need to search for an application, open the application, and navigate to a given page of the application to navigate to the digital location. Rather, the user may simply select the digital location indicated by the user interface to cause the user device to navigate to the digital location.

As a result, by enabling both location-based filtering and function-based filtering of locations, search results for locations may be associated with improved utility and/or accuracy for a user. For example, the search results (e.g., the one or more filtered locations) may include all locations (e.g., nearby a user device) at which a given function may be performed (e.g., including multiple location types). As a result, the search results may provide more insightful information for the user because the search results may depict and/or indicate physical locations that are located near the user device and at which the desired function can actually be performed. This conserves computing resources, processing resources, memory resources, and/or power resources, among other examples, associated with the user device filtering and/or identifying the search results that are not useful and/or misleading for the user (e.g., search results that include one or more false positive results). Further, this conserves computing resources, processing resources, memory resources, and/or power resources, among other examples, that would have otherwise been used by the user navigating to other pages and/or other applications to confirm that a physical location identified in the search results actually offers and/or supports a given function and/or service.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a user device 210, a server device 220, and a network 230. Devices of environment 200 may interconnect via wired connections, wireless connections, or a combination of wired and wireless connections.

The user device 210 may include one or more devices capable of receiving, generating, storing, processing, and/or providing information associated with location-based and function-based location filtering, as described elsewhere herein. The user device 210 may include a communication device and/or a computing device. For example, the user device 210 may include a wireless communication device, a mobile phone, a user equipment, a laptop computer, a tablet computer, a desktop computer, a gaming console, a wearable communication device (e.g., a smart wristwatch, a pair of smart eyeglasses, a head mounted display, or a virtual reality headset), or a similar type of device.

The server device 220 may include one or more devices capable of receiving, generating, storing, processing, providing, and/or routing information associated with location-based and function-based location filtering, as described elsewhere herein. The server device 220 may include a communication device and/or a computing device. For example, the server device 220 may include a server, such as an application server, a client server, a web server, a database server, a host server, a proxy server, a virtual server (e.g., executing on computing hardware), or a server in a cloud computing system. In some implementations, the server device 220 may include computing hardware used in a cloud computing environment.

The network 230 may include one or more wired and/or wireless networks. For example, the network 230 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 230 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with location-based and function-based location filtering. The device 300 may correspond to the user device 210 and/or the server device 220. In some implementations, the user device 210 and/or the server device 220 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

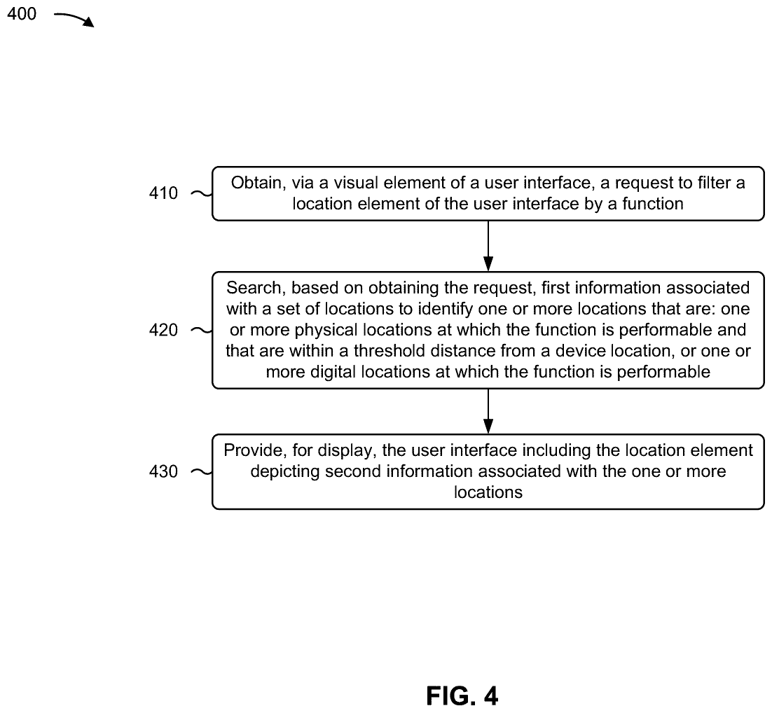

FIG. 4 is a flowchart of an example process 400 associated with location-based and function-based location filtering. In some implementations, one or more process blocks of FIG. 4 may be performed by the user device 210. In some implementations, one or more process blocks of FIG. 4 may be performed by another device or a group of devices separate from or including the user device 210, such as the server device 220. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining, via a visual element of a user interface, a request to filter a location element of the user interface by a function (block 410). For example, the user device 210 (e.g., using processor 320 and/or memory 330) may obtain, via a visual element of a user interface, a request to filter a location element of the user interface by a function, as described above in connection with reference number 115 of FIG. 1B. In some implementations, the visual element indicates the function. In some implementations, the device is associated with a device location (e.g., a user device location). As an example, the visual element may be a function filter chip. A user may provide a user input (e.g., a gestural interaction) that indicates a selection of the visual element.

As further shown in FIG. 4, process 400 may include searching, based on obtaining the request, first information associated with a set of locations to identify one or more locations that are: one or more physical locations at which the function is performable and that are within a threshold distance from the device location, or one or more digital locations at which the function is performable (block 420). For example, the user device 210 (e.g., using processor 320 and/or memory 330) may search, based on obtaining the request, first information associated with a set of locations to identify one or more locations that are: one or more physical locations at which the function is performable and that are within a threshold distance from the device location, or one or more digital locations at which the function is performable, as described above in connection with reference numbers 120, 125, 130, and/or 135 of FIG. 1B. As an example, the user device 210 may identify a set of locations that satisfy or meet one or more location-based criteria (e.g., that are within the threshold distance from the device location). The user device 210 may filter the set of locations, to identify a subset of locations, that are associated with a location type at which the function is performable. In some implementations, the user device 210 may determine whether the function is currently performable at each location included in the subset of locations (e.g., based on the first information). The one or more locations may include physical locations and/or digital locations at which the function is currently performable.

As further shown in FIG. 4, process 400 may include providing, for display, the user interface including the location element depicting second information associated with the one or more locations (block 430). For example, the user device 210 (e.g., using processor 320 and/or memory 330) may provide, for display, the user interface including the location element depicting second information associated with the one or more locations, as described above in connection with reference number 140 of FIG. 1C. As an example, the user device 210 may display an indication of physical locations (e.g., relative to the device location) and/or information for respective locations included in the one or more locations. In some implementations, the user device may display a link for a digital location that is selectable (e.g., by the user) to cause the user device to navigate to the digital location.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for location-based and function-based location filtering, the system comprising:
one or more memories; and
one or more processors, communicatively coupled to the one or more memories, configured to:
provide, for display, a user interface that includes a location element that indicates physical locations;
obtain, via a filter chip of the user interface, a request to filter the location element by a function,
wherein the filter chip indicates the function;
filter, using a device location associated with the system and the function, one or more locations from a set of locations,
wherein filtering using the function includes identifying that the function is performable at the one or more locations; and
provide, for display and based on obtaining the request to filter the location element by the function, the location element indicating the one or more locations.

2. The system of claim 1, wherein the one or more processors, to provide the user interface, are configured to:
provide, for display, multiple filter chips associated with respective functions,
wherein the multiple filter chips are associated with filtering the physical locations indicated by the location element, and
wherein the multiple filter chips include the filter chip.

3. The system of claim 1, wherein the one or more locations include one or more digital locations.

4. The system of claim 1, wherein the function includes a service offered by a location.

5. The system of claim 1, wherein the one or more locations include multiple locations associated with different location types.

6. The system of claim 5, wherein the user interface is associated with a first entity, and wherein the different location types include at least one of:
first one or more location types associated with the first entity,
a cash machine associated with the first entity, or
second one or more location types associated with a second entity, wherein the second one or more location types provide services for the first entity.

7. The system of claim 1, wherein the one or more processors, to filter the one or more locations from the set of locations, are configured to:
identify that a first location, from the set of locations, is located in a second location and that the function is performable at the first location; and
include the first location in the one or more locations based on an availability of the second location.

8. The system of claim 1, wherein the one or more processors, to filter the one or more locations from the set of locations, are configured to:
identify that a location, from the set of locations, is associated with a location type that supports the function and that the function is performable at the location;
obtain information indicating that the function is currently unavailable at the location; and
refrain, based on the function being currently unavailable, from including the location in the one or more locations.

9. A method of location-based and function-based location searching, comprising:
obtaining, by a device and via a visual element of a user interface, a request to filter a location element of the user interface by a function,
wherein the visual element indicates the function, and
wherein the device is associated with a device location;
searching, by the device and based on obtaining the request, first information associated with a set of locations to identify one or more locations that are:
one or more physical locations at which the function is performable and that are within a threshold distance from the device location, or
one or more digital locations at which the function is performable; and
providing, by the device and for display, the user interface including the location element depicting second information associated with the one or more locations.

10. The method of claim 9, further comprising:
providing, for display via the device, the user interface including multiple visual elements associated with respective functions, wherein the multiple visual elements include the visual element, and
wherein obtaining the request comprises:
obtaining an indication of a user input selecting the visual element from the multiple visual elements.

11. The method of claim 9, wherein the visual element is a filter chip associated with filtering locations by the function.

12. The method of claim 9, wherein the user interface is associated with an application executing on the device, and wherein the one or more digital locations include at least one of:
a page of the application, or
a webpage associated with an entity that is associated with the application.

13. The method of claim 9, further comprising:
obtaining, via the user interface, an indication of a user input selecting a digital location from the one or more digital locations; and
navigating, based on obtaining the indication of the user input, to the digital location.

14. The method of claim 9, wherein searching the first information associated with the set of locations comprises:
filtering, to obtain a subset of locations, the set of locations by one or more location types that are associated with supporting the function; and
determining whether the function is currently performable at each location included in the subset of locations,
wherein the one or more locations include locations, from the subset of locations,
at which the function is currently performable.

15. The method of claim 9, further comprising:
obtaining operational status information associated with a location included in the one or more locations,
wherein the operational status information indicates whether a device associated with the location is currently capable of performing the function; and
including the location in the one or more locations based on the operational status information indicating that the device is currently capable of performing the function.

16. The method of claim 9, wherein the one or more locations include a first location associated with a physical location and a second location associated with the physical location,
wherein the first location is associated with a first location type and the second location is associated with a second location type, and
wherein providing the user interface comprises:
providing, for display, the location element,
wherein the location element includes a map element,
wherein the map element includes an indicator associated with the physical location, and
wherein the indicator is associated with the first location based on the first location type having a higher priority level than a priority level of the second location type for the function.

17. A non-transitory computer-readable medium storing a set of instructions, the set of instructions comprising:
one or more instructions that, when executed by one or more processors of a device, cause the device to:
provide, for display, a user interface that includes a location element that depicts location indicators;
obtain, via a filter chip of the user interface, a request to filter the location element by a function,
filter, using a device location associated with the device and the function, one or more locations from a set of locations,
wherein the function is performable at the one or more locations; and
provide, for display and based on obtaining the request to filter the location element by the function, the location element indicating the one or more locations.

18. The non-transitory computer-readable medium of claim 17, wherein the one or more instructions, that cause the device to provide the user interface, cause the device to:
provide, for display, multiple filter chips associated with respective functions,
wherein the multiple filter chips are associated with filtering the location indicators, and
wherein the multiple filter chips include the filter chip.

19. The non-transitory computer-readable medium of claim 17, wherein the one or more instructions, that cause the device to filter the one or more locations from the set of locations, cause the device to:
identify that a first location, from the set of locations, is located in a second location and that the function is performable at the first location; and
include the first location in the one or more locations based on an availability of the second location.

20. The non-transitory computer-readable medium of claim 17, wherein the one or more instructions, that cause the device to filter the one or more locations from the set of locations, cause the device to:
identify that a location, from the set of locations, is associated with a location type that supports the function and that the function is performable at the location;
obtain information indicating that the function is offline at the location; and
refrain, based on the function being currently unavailable, from including the location in the one or more locations.
